(19) United States
(12) Patent Application Publication
(10) Pub. No.: US 2016/0266234 A1
(43) Pub. Date: Sep. 15, 2016

(54) Method, Apparatus, and Computer Program Product for Determining an Object Position based on Range Data and Determined Location Data

(71) Applicant: ZIH Corp., Lincolnshire, IL (US)

(72) Inventor: Stephen Pearce, Fremont, CA (US)

(21) Appl. No.: 15/068,533

(22) Filed: Mar. 11, 2016

Related U.S. Application Data
(60) Provisional application No. 62/132,039, filed on Mar. 12, 2015.

(51) Int. Cl. G01S 5/14; G01S 5/02

(52) U.S. Cl. CPC G01S 5/14; G01S 5/0252; G01S 5/0221

(57) ABSTRACT

A method, apparatus and computer program product are provided for determining an object position based on range data and determined location data. In the context of a method, the method includes receiving blink data from location tag at a plurality of receivers, determining a tag location based on the blink data, receiving range data from the location tag at a plurality of range detectors based on the tag location, and determining a precision tag position based on the range data.

### RELATED APPLICATION

This patent claims the benefit of U.S. Provisional Patent Ser. No. 62/132,039, filed Mar. 12, 2015, which is hereby incorporated herein by reference in its entirety.

### FIELD

Embodiments discussed herein are related to radio frequency locating and range determination and, more particularly, to systems, methods, apparatus, and computer readable media for determining an object position based on range data and determined location data.

### BACKGROUND

Construction projects are a complicated process which rely on accurate placement of structure components and structural element. Even slight variations introduced during the building process may cause significant integrity issues which may have to be corrected by costly means, such as deconstructing portions or all of the structure. Currently no method exists for automated determination or monitoring of structural components and structural elements during the construction process.

A number of deficiencies and problems associated with providing automated determination or monitoring of structural components and structural elements during the construction process are identified herein. Through applied effort, ingenuity, and innovation, exemplary solutions to many of these identified problems are embodied by the present invention, which is described in detail below.

### BRIEF SUMMARY

A method, apparatus and computer program product are provided in accordance with an example embodiment for determining an object position based on range data and determined location data. In an example embodiment a system for monitoring target locations of components in construction of a structure is provided including a location tag configured to transmit blink data, a plurality of receivers configured to receive the blink data, a plurality of range detectors configured to receive range data from the location tag, and a receiver hub in data communication with the plurality of receivers and the plurality of range detectors, configured to receive blink data from the plurality of receivers, determine a tag location based on the blink data, receive range data from the plurality of range detectors based on the tag location, and determine a precision tag position based on the range data.

In some example embodiments of the system for monitoring target locations of components in construction of a structure, the receiver hub is further configured to aim the plurality of range detectors based on the tag location and the receiving range data includes receiving a plurality of reflections from the location tag. In an example embodiment of the system for monitoring target locations of components in construction of a structure, the receiver hub is further configured to compare the precision tag position to a target location and determine if the precision tag position satisfies a target location threshold.

In an example embodiment of the system for monitoring target locations of components in construction of a structure, the receiver hub is further configured to cause the transmission of an alert in an instance in which the precision tag position fails to satisfy the target location threshold. In some example embodiments, the system for monitoring target locations of components in construction of a structure also includes a plurality of reference tags associated with the plurality of receivers and the plurality of range detectors, configured to transmit reference blink data. The plurality of receivers are further configured to receive reference blink data from the plurality of reference tags associated with the plurality of receivers and the plurality of range detectors are further configured to receive reference range data from the plurality of reference tags associated with the plurality of range detectors. The receiver hub is further configured to receive reference blink data from the plurality of receivers, determine reference tag locations associated with locations of the respective receivers of the plurality of receivers based on the reference blink data, receive reference range data from the plurality of range detectors based on the reference tag locations; and determine a reference precision tag position associated with positions of the respective range detectors of the plurality of range detectors based on the reference range data. The determining the tag location is further based on a reference tag locations of the respective receivers and the determining the precision tag position is further based on the reference precision tag positions of the respective range detectors.

In an example embodiment, the system for monitoring target locations of components in construction of a structure also includes a reference tag associated with a reference point configured to transmit reference blink data and the plurality of receivers are further configured to receive reference blink data from reference tags. The plurality of range detectors are further configured to receive reference range data from the reference tag. The receiver hub is further configured to receive reference blink data from the plurality of receivers, determine a reference tag location, receive reference range data from the plurality of range detectors based on the reference tag location, and determine a reference precision tag position. The determining the tag location is further based on a reference tag location and the determining the precision tag position is further based on the reference precision tag position.

In some example embodiments of the system for monitoring target locations of components in construction of a structure, the receiver hub is further configured to determine if the tag location is in a transitory state or a non-transitory state and suspend the aiming the range detector, the receiving a plurality of reflections, and determining the precision tag position, in an instance in which the tag location is determined to be in a transitory state. In an example embodiment of the system for monitoring target locations of components in construction of a structure, the plurality of range detectors are a plurality of laser range finders and the plurality of reflections are laser reflections.

In an example embodiment of the system for monitoring target locations of components in construction of a structure, the tag location and precision tag position comprise a three dimensional coordinate set. In some example embodiments of the system for monitoring target locations of components in construction of a structure, the tag location and precision tag position comprise two dimensional coordinate set.

In another example embodiment, a method is provided including receiving blink data from location tag at a plurality of receivers, determining a tag location based on the blink data, receiving range data from the location tag at a plurality of range detectors based on the tag location, and determining a precision tag position based on the range data.

In an example embodiment, the method further comprises aiming the plurality of range detectors based on the tag location and the receiving range data comprises receiving a plurality of reflections from the location tag. In some example embodiments, the method also includes comparing the precision tag position to a target location and determining if the precision tag position satisfies a target location threshold. In some example embodiments, the method also includes causing the transmission of an alert in an instance in which the precision tag position fails to satisfy the target location threshold.

In an example embodiment, the method also includes determining locations of the respective receivers of the plurality of receivers and a positions of respective range detectors of the plurality of range detectors and determining the tag location is further based on the locations of the respective receivers and determining the precision tag position is further based on the positions of the respective range detectors. In some example embodiments, the method also includes determining a reference location and the determining the tag location and determining the precision tag position is further based on the reference location.

In an example embodiment, the method also includes determining if the tag location is in a transitory state or a non-transitory state and suspending the aiming the range detectors finder, the receiving a plurality of reflections, and determining the precision tag position, in an instance in which the tag location is determined to be in a transitory state. In an example embodiment of the method, the plurality of range detectors are a plurality of laser range finders and the range data is laser reflections

In some example embodiments of the method, the tag location and precision tag position comprise a three dimensional coordinate set. In an example embodiment of the method the tag location and precision tag position comprise two dimensional coordinate set.

In yet a further example embodiment, a method for monitoring target locations of components in construction of a structure is provided including receiving blink data from location tag mounted on a structure component or structural element at a plurality of receivers, determining a tag location based on the blink data, receiving range data from the location tag at a plurality of range detectors based on the tag location, and determining a precision tag position based on the range data.

In an example embodiment of the method for monitoring target locations of components in construction of a structure further comprises aiming the plurality of range detectors based on the tag location and the receiving range data comprises receiving a plurality of reflections from the location tag. In some example embodiments, the method for monitoring target locations of components in construction of a structure also includes comparing the precision tag position to a target location defined by a three dimensional model of the structure, and determining if the precision tag position satisfies a target location threshold.

In some example embodiments, the method for monitoring target locations of components in construction of a structure also includes causing the transmission of an alert in an instance in which the precision tag position fails to satisfy the target location threshold. In an example embodiment, the method for monitoring target locations of components in construction of a structure also includes determining locations of the respective receivers of the plurality of receivers and a positions of respective range detectors of the plurality of range detectors and determining the tag location is further based on the locations of the respective receivers and determining the precision tag position is further based on the positions of the respective range detectors.

In some example embodiments, the method for monitoring target locations of components in construction of a structure also includes receiving reference blink data from a reference tag mounted at a fixed position on the structure and determining a reference location based on the reference blink data. The determining the tag location and determining the precision tag position is further based on the reference location. In an example embodiment, the method for monitoring target locations of components in construction of a structure also includes determining if the tag location is in a transitory state or a non-transitory state and suspending the aiming the range detectors, the receiving a plurality of reflections, and determining the precision tag position, in an instance in which the tag location is determined to be in a transitory state. In an example embodiment of the method for monitoring target locations of components in construction of a structure, plurality of range detectors comprises a plurality of laser range finders and the range data is a plurality of laser reflections.

In an example embodiment of the method for monitoring target locations of components in construction of a structure, the tag location and precision tag position comprise a three dimensional coordinate set. In some example embodiments of the method for monitoring target locations of components in construction of a structure, the tag location and precision tag position comprise two dimensional coordinate set.

In an example embodiment, the method for monitoring target locations of components in construction of a structure also includes receiving blink data from a second location tag mounted to the structure or structural component, determining a second tag location based on the blink data from the second location tag, receiving range data form the second location tag based on the second tag location, determining a second precision tag position based on the range data, The comparing the precision tag position to the target location is further based on the second precision tag position.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a schematic representation of a radio frequency locating system useful for determining the location of an object according to an example embodiment of the present invention;

FIG. 2 illustrates an example monitoring grid and monitoring grid anchor determination in accordance with an example embodiment of the present invention;

FIG. 3A illustrates an example receiver and LRF mounting position in accordance with an example embodiment of the present invention;

FIG. 3B illustrates an example location tag in accordance with an example embodiment of the present invention;

FIG. 4 illustrates an example precision tag position determination in accordance with an example embodiment of the present invention;

FIG. 5 illustrates and example tag location and precision tag position radii in accordance with an example embodiment of the present invention;

FIG. 6 illustrates an example structure component or structural element position determination in accordance with an example embodiment of the present invention;

FIG. 7 illustrates an example precision tag position determination based on other precision tag positions in accordance with an example embodiment of the present invention;

FIG. 8 illustrates a block diagram of components that may be included in an apparatus configured for determining an object position based on range data and determined location data in accordance with an example embodiment of the present invention; and

FIG. 9 illustrates a flowchart of an exemplary process for determining an object position based on range data and determined location data in accordance with an example embodiment of the present invention.

### DETAILED DESCRIPTION

The present invention now will be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

### Overview

Existing methods for determining placement of structure components and structural elements in building projects relies on surveying the structure as the structure is constructed. This may require several survey crews to perform surveys of the structure for placement of key components and structural elements. The surveys crews must then reperform surveys of structure components and structural elements as further structure components and structural elements are added during the constructions process to monitor for variation or deviation.

Although radio frequency location monitoring systems exist which have subfoot resolution, these location technologies may not be accurate enough for the precise constraints of structure construction, such as buildings. In fact, even a very small variation could cause catastrophic deviations as the structure progresses, therefore requiring a high accuracy, such as ¼ or ⅛ of an inch.

A location determination based on a high resolution, e.g. subfoot, may be used as an input to a range detector, such as a laser range finder. The location data may be used to aim the laser range finder at a specified component to determine a position of the component. The component positions may then be compared to the structural specification or three dimensional model to determine if the component is properly placed. Additionally, the system may be configured to automatically verify the positions of components after placement and cause an alert in an instance in which the component position moves from a target location

In an example embodiment, retro reflectors may be mounted to the location tags to reflect light from the laser range finder for precise position determinations. The position monitoring system may include three or more receivers with associated laser range finders. A reference tag may be mounted to each receiver/laser range finder pair and used to determine a monitoring grid. Additionally, one or more reference tags may be mounted to fixed positions within the monitored area, or associated with the structure, such as the foundation corners of the structure, to anchor the monitoring grid to a known reference position relative to the structure. In an example embodiment, the receiver/laser rangefinder pairs may be a high receiver/laser rangefinder pair and a low receiver/laser range finder pair, to provide three dimensional positioning.

One location tags with mounted retro reflectors may be mounted to respective positions on a structure component. The monitoring system may determine the location of the location tag and use the tag location to aim the laser range finders at the tag. The laser range finders may receive proximity data, e.g. a range measurement, for each laser range finder relative to the location tag or tags. The monitoring system may determine a precision tag position based on the range data by triangulation. The monitoring system may compare the precision tag positions to the target position based on a three dimensional structure model, such as a computer automated drawing (CAD). This may allow real time verification of structure component and structural element placement, reducing the man-hours required for each placement, associated with manually surveying.

The location tags may remain mounted to the various structure components and structural elements as the structure construction process progresses. The monitoring system may automatically verify the position of the location tags at a predetermined interval and cause an alert to be transmitted in an instance in which the precision tag position fails to satisfy a predetermined threshold associated with the target location. This alert may provide a real time or near real time indication of a structural variance allowing for immediate secession of construction. This may also allow for a correction of the variance while minimizing or eliminating the need to deconstruct the structure, saving thousands or even millions of dollars in man-hours and materials.

As used herein, the term “tag location” refers to an ultrawide band (UWB) tag location determination that is based at least in part on blink data received form one or more location tags, which may have a subfoot accuracy.

The term “tag position” refers to a determined position of a location tag based on global positioning (GPS), differential global positioning (DGPS), proximity sensing, or other non-UWB positioning technologies, i.e. technologies not based on blink data.

The term “precision tag position” refers to a position of a tag as determined using range data, such as from laser range finders configured as discussed herein to have a subinch accuracy of in at least an x and y axis. Preferably, the range data provided by the laser range finders for determination of the precision tag position have a sub inch accuracy of less in an x, y, and z axis.

### Example RF Locating System Architecture

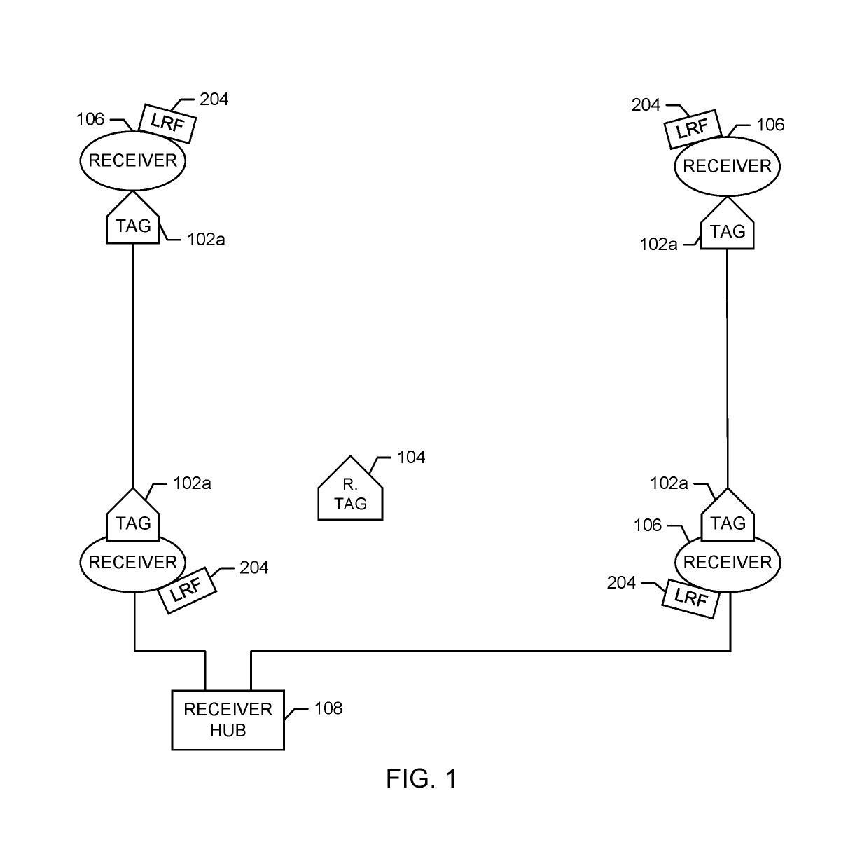

FIG. 1 illustrates an exemplary locating system 100 useful for calculating a location by an accumulation of location data or time of arrivals (TOAs) at a receiver hub 108, whereby the TOAs represent a relative time of flight (TOF) from real time location system (RTLS) location tags 102 as recorded at each receiver 106 (e.g. UWB reader, etc.).

The depicted location tag 102 may generate or store a tag unique identifier (“tag UID”) and/or tag data as shown. The tag data may include useful information such as the installed firmware version, last tag maintenance date, configuration information, and/or a tag-object correlator. The tag-object correlator may comprise data that indicates that a monitored object is associated with the location tag 102 (e.g. structure component, structural element, mounting position, tag UID, or the like). As will be apparent to one of skill in the art in view of this disclosure, the tag-object correlator may be stored to the location tag 102 when the tag is registered or otherwise associated with an object.

The tag signal transmitted from location tag 102 to receiver 106 may include “blink data” as it is transmitted at selected intervals. The blink data may have an associated “blink rate,” which may be set by the tag designer or the system designer to meet application requirements. In some embodiments it is consistent for one or all tags; in some embodiments it may be data dependent. Blink data includes characteristics of the tag signal that allow the tag signal to be recognized by the receiver 106 so the location of the location tag 102 may be determined by the locating system. Blink data may also comprise one or more tag data packets. Such tag data packets may include any data from the tag 102 that is intended for transmission such as, a tag UID, tag data, a tag-object correlator, sensor data, or the like. In the case of TDOA systems, the blink data may be or include a specific pattern, code, or trigger that the receiver 106 (or downstream receiver hub 108) detects to identify that the transmission is from a location tag 102 (e.g. a UWB tag).

The depicted receiver 106 receives the tag signal, which includes blink data and tag data packets as discussed above. In one embodiment, the receiver 106 may pass the received tag signal directly to the receive receiver hub 108 as part of its receiver signal. In another embodiment, the receiver 106 could perform some basic processing on the received tag signal. For instance, the receiver could extract blink data from the tag signal and transmit the blink data to the receive receiver hub 108. The receiver could transmit a time measurement to the receive receiver hub 108 such as a TOA measurement and/or a TDOA measurement. The time measurement could be based on a clock time generated or calculated in the receiver, it could be based on a receiver offset value as explained below, it could be based on a system time, and/or it could be based on the time difference of arrival between the tag signal of the location tag 102 and the tag signal of a reference tag 104. The receiver 106 could additionally or alternatively determine a signal measurement from the tag signal (such as a received signal strength indication (RSSI), a direction of signal, signal polarity, or signal phase) and transmit the signal measurement to the receive receiver hub/locate engine 108.

A timing reference clock is used, in some examples, such that at least a subset of the receivers 106 may be synchronized in frequency, whereby the relative TOA data associated with each of the location tags 102 may be registered by a counter associated with at least a subset of the receivers 106. In some examples, a reference tag 104, preferably a UWB transmitter, positioned at known coordinates, for example a foundation corner of a structure, is used to determine a phase offset between the counters associated with at least a subset of the of the receivers 106. The location tags 102 and the reference tags 104 reside in an active RTLS field. The systems described herein may be referred to as either “multilateration” or “geolocation” systems, terms that refer to the process of locating a signal source by solving an error minimization function of a location estimate determined by the difference in time of arrival (DTOA) between TOA signals received at multiple receivers 106.

In some examples, the system comprising at least the location tags 102 and the receivers 106 is configured to provide two dimensional and/or three dimensional precision localization (e.g. subfoot resolutions), even in the presence of multipath interference, due in part to the use of short nanosecond duration pulses whose TOF can be accurately determined using detection circuitry, such as in the receivers 106, which can trigger on the leading edge of a received waveform. In some example embodiments, the receivers 106 may trigger based on determining a specified point on the leading edge, such as a slope 3-6 dB from the peak. In some examples, this short pulse characteristic allows necessary data to be conveyed by the system at a higher peak power, but lower average power levels, than a wireless system configured for high data rate communications, yet still operate within local regulatory requirements.

In some examples, to provide a preferred performance level while complying with the overlap of regulatory restrictions (e.g. FCC and ETSI regulations), the location tags 102 may operate with an instantaneous −3 dB bandwidth of approximately 400 MHz and an average transmission below 187 pulses in a 1 msec interval, provided that the packet rate is sufficiently low. In such examples, the predicted maximum range of the system, operating with a center frequency of 6.55 GHz, is roughly 200 meters in instances in which a 12 dBi directional antenna is used at the receiver, but the projected range will depend, in other examples, upon receiver antenna gain. Alternatively or additionally, the range of the system allows for one or more tags 102 to be detected with one or more receivers positioned throughout a football stadium used in a professional football context. Such a configuration advantageously satisfies constraints applied by regulatory bodies related to peak and average power densities (e.g. effective isotropic radiated power density (“EIRP”)), while still optimizing system performance related to range and interference. In further examples, tag transmissions with a −3 dB bandwidth of approximately 400 MHz yields, in some examples, an instantaneous pulse width of roughly 2 nanoseconds that enables a location resolution to better than 30 centimeters.

Referring again to FIG. 1, the object to be located has an attached location tag 102, preferably a tag having a UWB transmitter, that transmits a burst (e.g. multiple pulses at a 1 Mb/s burst rate, such as 112 bits of On-Off keying (OOK) at a rate of 1 Mb/s), and optionally, a burst comprising an information packet utilizing OOK that may include, but is not limited to, ID information, a sequential burst count or other desired information for object or personnel identification, inventory control, etc. In some examples, the sequential burst count (e.g. a packet sequence number) from each location tag 102 may be advantageously provided in order to permit, at a receiver hub 108, correlation of TOA measurement data from various receivers 106.

In some examples, the tag 102 may employ UWB waveforms (e.g. low data rate waveforms) to achieve extremely fine resolution because of their extremely short pulse (i.e., sub-nanosecond to nanosecond, such as a 2 nsec (1 nsec up and 1 nsec down)) durations. As such, the information packet may be of a short length (e.g. 112 bits of OOK at a rate of 1 Mb/sec, in some example embodiments), that advantageously enables a higher packet rate. In an instance in which each information packet is unique, a higher packet rate results in a higher data rate; in an instance in which each information packet is transmitted repeatedly, the higher packet rate results in a higher packet repetition rate. In some examples, higher packet repetition rate (e.g. 12 Hz, 100 Hz, 200 Hz, or the like) and/or higher data rates (e.g. 1 Mb/sec, 2 Mb/sec, 4 Mb/sec, or the like) for each tag may result in larger datasets for filtering to achieve a more accurate location estimate. Alternatively or additionally, in some examples, the shorter length of the information packets, in conjunction with other packet rate, data rates and other system requirements, may also result in a longer battery life (e.g. 7 years battery life at a transmission rate of 1 Hz with a 300 mAh cell, in some present embodiments). In other embodiments, a 90 mAh, 55 mAh, or other mAh rated battery may be used, based on the needed life of the location tag, and or location tag power requirements.

Tag signals may be received at a receiver directly from location tags 102, or may be received after being reflected en route. Reflected signals travel a longer path from the location tag to the receiver than would a direct signal, and are thus received later than the corresponding direct signal. This delay is known as an echo delay or multipath delay. In an instance in which reflected signals are sufficiently strong enough to be detected by the receiver, they can corrupt a data transmission through inter-symbol interference. In some examples, the location tag 102 may employ UWB waveforms to achieve extremely fine resolution because of their extremely short pulse (e.g. 2 nsec) durations. Furthermore, signals may comprise short information packets (e.g. 112 bits of OOK) at a somewhat high burst data rate (1 Mb/sec, in some example embodiments), that advantageously enable packet durations to be brief (e.g. 112 microsec) while allowing inter-pulse times (e.g. 998 nsec) sufficiently longer than expected echo delays, avoiding data corruption.

Reflected signals can be expected to become weaker as delay increases due to more reflections and the longer distances traveled. Thus, beyond some value of inter-pulse time (e.g. 998 nsec), corresponding to some path length difference (e.g. 299.4 m.), there will be no advantage to further increases in inter-pulse time (and, hence lowering of burst data rate) for any given level of transmit power. In this manner, minimization of packet duration allows the battery life of a tag to be maximized, since its digital circuitry need only be active for a brief time. It will be understood that different environments can have different expected echo delays, so that different burst data rates and, hence, packet durations, may be appropriate in different situations depending on the environment.

Minimization of the packet duration also allows a location tag 102 to transmit more packets in a given time period, although in practice, regulatory average EIRP limits may often provide an overriding constraint. However, brief packet duration also reduces the likelihood of packets from multiple tags overlapping in time, causing a data collision. Thus, minimal packet duration allows multiple tags to transmit a higher aggregate number of packets per second, allowing for the largest number of tags to be tracked, or a given number of tags to be tracked at the highest rate.

In one non-limiting example, a data packet length of 112 bits (e.g. OOK encoded), transmitted at a data rate of 1 Mb/sec (1 MHz), may be implemented with a transmit tag repetition rate of 1 transmission per second (1 TX/sec). Such an implementation may accommodate a battery life of up to seven years, wherein the battery itself may be, for example, a compact, 3-volt coin cell of the series no. BR2335 (Rayovac), with a battery charge rating of 300 mAhr. An alternate implementation may be a generic compact, 3-volt coin cell, series no. CR2032, with a battery charge rating of 220 mAhr, whereby the latter generic coin cell, as can be appreciated, may provide for a shorter battery life.

Alternatively or additionally, some applications may require higher transmit tag repetition rates to track a dynamic environment. In some examples, the transmit tag repetition rate may be 12 transmissions per second (12 TX/sec). In such applications, it can be further appreciated that the battery life may be shorter.

The high burst data transmission rate (e.g. 1 MHz), coupled with the short data packet length (e.g. 112 bits) and the relatively low repetition rates (e.g. 1 TX/sec), provide for two distinct advantages in some examples: (1) a greater number of tags may transmit independently from the field of tags with a lower collision probability, and/or (2) each independent tag transmit power may be increased, with proper consideration given to a battery life constraint, such that a total energy for a single data packet is less than a regulated average power for a given time interval (e.g. a 1 msec time interval for an FCC regulated transmission).

Alternatively or additionally, additional sensor or telemetry data may be transmitted from the tag to provide the receivers 106 with information about the environment and/or operating conditions of the tag. For example, the tag may transmit a temperature to the receivers 106. Such information may be valuable, for example, in construction of a structure where thermal effects may introduce variance in the structure components of structural elements. In this example embodiment, the temperature may be transmitted by the tag at a lower repetition rate than that of the rest of the data packet. For example, the temperature may be transmitted from the location tag to the receivers at a rate of one time per minute (e.g. 1 TX/min.), or in some examples, once every 720 times the data packet is transmitted, whereby the data packet in this example is transmitted at an example rate of 12 TX/sec. Other example sensor data may include motion sensor data, such as motion sensor data form an accelerometer, or strain data from a strain gauge sensor.

In some embodiments the location tags 102 may include a near field communication interface, Bluetooth Low Energy (BLE) interface, or similar short range radio frequency communication interface. Sensors which are mounted within range of the location tag's 102 short range RF interface may transmit sensor data, such as temperature, motion, strain, or the like to the location tag. The location tag 102 may include the sensor data from the sensors in a data packet of the blink data, as described above. Sensor data included in the data packet may be received by one or more receivers 106 and sent to the receiver hub 108 for processing.

Alternatively or additionally, the location tag 102 may be programmed to intermittently transmit data to the receivers 106 in response to a signal from a magnetic command transmitter (not shown). The magnetic command transmitter may be a portable device, functioning to transmit a 125 kHz signal, in some example embodiments, with a range of approximately 15 feet or less, to one or more of the tags 102. In some examples, the tags 102 may be equipped with at least a receiver tuned to the magnetic command transmitter transmit frequency (e.g. 125 kHz) and functional antenna to facilitate reception and decoding of the signal transmitted by the magnetic command transmitter. In an example embodiment, the magnetic command transmitter may be used to cause the location tags 102 to transmit blink data when the location tags are mounted, or in an instance in which a location tag is near a target location, as discussed below to minimize the number of location tags being monitored at any given time.

In some examples, one or more other tags, such as a reference tag 104, may be positioned within and/or about a monitored region. In some examples, the reference tag 104 may be configured to transmit a signal that is used to measure the relative phase (e.g. the count of free-running counters) of non-resettable counters within the receivers 106.

One or more (e.g. preferably four or more) receivers 106 are also positioned at predetermined coordinates within and/or around the monitored region. In some examples, the receivers 106 may be connected in a “daisy chain” fashion to advantageously allow for a large number of receivers 106 to be interconnected over a significant monitored region in order to reduce and simplify cabling, provide power, and/or the like. In another example embodiment, the receivers may be connected via a wireless connection. Each of the receivers 106 includes a receiver for receiving transmissions, such as UWB transmissions, and preferably, a packet decoding circuit that extracts a time of arrival (TOA) timing pulse train, transmitter ID, packet number, and/or other information that may have been encoded in the tag transmission signal (e.g. material description, personnel information, etc.) and is configured to sense signals transmitted by the location tags 102 and one or more reference tags 104.

Each receiver 106 includes a time measuring circuit that measures times of arrival (TOA) of tag bursts, with respect to its internal counter. The time measuring circuit is phase-locked (e.g. phase differences do not change and therefore respective frequencies are identical) with a common digital reference clock signal distributed via cable connection from a receiver hub 108 having a central timing reference clock generator. The reference clock signal establishes a common timing reference for the receivers 106. Thus, multiple time measuring circuits of the respective receivers 106 are synchronized in frequency, but not necessarily in phase. While there typically may be a phase offset between any given pair of receivers in the receivers 106, the phase offset is readily determined through use of a reference tag 104, e.g. a reference phase offset. Alternatively or additionally, each receiver may be synchronized wirelessly via virtual synchronization without a dedicated physical timing channel.

In some example embodiments, the receivers 106 are configured to determine various attributes of the received signal. Since measurements are determined at each receiver 106, in a digital format, rather than analog in some examples, signals are transmittable to the receiver hub 108. Advantageously, because packet data and measurement results can be transferred at high speeds to a receiver memory, the receivers 106 can receive and process tag (and corresponding object) locating signals on a nearly continuous basis. As such, in some examples, the receiver memory allows for a high burst rate of tag events (i.e., information packets) to be captured.

Data cables or wireless transmissions may convey measurement data from the receivers 106 to the receiver hub 108 (e.g. the data cables may enable a transfer speed of 2 Mbps). In some examples, measurement data is transferred to the receiver hub at regular polling intervals.

As such, the receiver hub 108 determines or otherwise computes tag location (i.e., object location) by processing TOA measurements relative to multiple data packets detected by the receivers 106. In some example embodiments, the receiver hub 108 may be configured to resolve the coordinates of a tag using nonlinear optimization techniques.

In some examples, TOA measurements from multiple receivers 106 are processed by the receiver hub 108 to determine a location of the transmit location tag 102 by a differential time-of-arrival (DTOA) analysis of the multiple TOAs. The DTOA analysis includes a determination of tag transmit time t₀, whereby a time-of-flight (TOF), measured as the time elapsed from the estimated tag transmit time t₀ to the respective TOA, represents graphically the radii of spheres centered at respective receivers 106. The distance between the surfaces of the respective spheres to the estimated location coordinates (x₀, y₀, z₀) of the transmit tag 102 represents the measurement error for each respective TOA, and the minimization of the sum of the squares of the TOA measurement errors from each receiver participating in the DTOA location estimate provides for both the location coordinates (x₀, y₀, z₀) of the transmit tag and of that tag's transmit time t₀.

In some examples, the system described herein may be referred to as an “over-specified” or “over-determined” system. As such, the receiver hub 108 may calculate one or more valid (i.e., most correct) locations based on a set of measurements and/or one or more incorrect (i.e., less correct) locations. For example, a location may be calculated that is impossible due the laws of physics or may be an outlier when compared to other calculated locations. As such one or more algorithms or heuristics may be applied to minimize such error.

The starting point for the minimization may be obtained by first doing an area search on a coarse grid of x, y and z over an area defined by the user and followed by a localized steepest descent search. The starting location for this algorithm is fixed, in some examples, at the mean position of all active receivers. No initial area search is needed, and optimization proceeds through the use of a Davidon-Fletcher-Powell (DFP) quasi-Newton algorithm in some examples. In other examples, a steepest descent algorithm may be used.

One such algorithm for error minimization, which may be referred to as a time error minimization algorithm, may be described in Equation 1:

$$ɛ = {\sum }_{j = 1}^{N} {[ {[ {( x - {x}_{j} )}^{2} + {( y - {y}_{j} )}^{2} + {( z - {z}_{j} )}^{2} ]}^{\frac{1}{2}} - c ( {t}_{j} - {t}_{0} ) ]}^{2} \qquad ( 1 )$$

In an instance in which N is the number of receivers, c is the speed of light, (xⱼ, yⱼ, zⱼ) are the coordinates of the j^{th} receiver, tⱼ is the arrival time at the j^{th} receiver, and t₀ is the tag transmit time. The variable t₀ represents the time of transmission. Since t₀ is not initially known, the arrival times, tⱼ, as well as t₀, are related to a common time base, which in some examples, is derived from the arrival times. As a result, differences between the various arrival times have significance for determining location as well as t₀.

The optimization algorithm to minimize the error ε in Equation 1 may be the Davidon-Fletcher-Powell (DFP) quasi-Newton algorithm, for example. In some examples, the optimization algorithm to minimize the error ε in Equation 1 may be a steepest descent algorithm. In each case, the algorithms may be seeded with an initial location estimate (x, y, z) that represents the two-dimensional (2D) or three-dimensional (3D) mean of the positions of the receivers 106 that participate in the tag location determination.

In some examples, the RTLS system comprises a receiver grid, whereby each of the receivers 106 in the receiver grid keeps a receiver clock that is synchronized, with an initially unknown phase offset, to the other receiver clocks. The phase offset between any receivers may be determined by use of a reference tag that is positioned at a known coordinate position (x_{T}, y_{T}, z_{T}). The phase offset serves to resolve the constant offset between counters within the various receivers 106, as described below.

In further example embodiments, a number N of receivers 106 {Rⱼ j=1, . . . , N} are positioned at known coordinates (x_{R}_{ⱼ}, y_{R}_{ⱼ}, z_{R}_{ⱼ}), which are respectively positioned at distances d_{R}_{ⱼ} from a reference tag 104, such as given in Equation 2:

d_{R}_{ⱼ}=\sqrt{(x_{R}_{ⱼ}−x_{T})²+(y_{R}_{ⱼ}−y_{T})²+(z_{R}_{ⱼ}−z_{T})²} (2)

Each receiver Rⱼ utilizes, for example, a synchronous clock signal derived from a common frequency time base, such as a clock generator. Because the receivers are not synchronously reset, an unknown, but constant offset Oⱼ exists for each receiver's internal free running counter. The value of the constant offset Oⱼ is measured in terms of the number of fine resolution count increments (e.g. a number of nanoseconds for a one nanosecond resolution system).

The reference tag is used, in some examples, to calibrate the radio frequency locating system as follows: The reference tag emits a signal burst at an unknown time TR. Upon receiving the signal burst from the reference tag, a count N_{R}_{ⱼ} as measured at receiver Rⱼ is given in Equation 3 by:

N_{R}_{ⱼ}=βτ_{R}+Oⱼ+βd_{R}_{ⱼ}/c (3)

In an instance in which c is the speed of light and β is the number of fine resolution count increments per unit time (e.g. one per nanosecond). Similarly, each object tag Tᵢ of each object to be located transmits a signal at an unknown time τᵢ to produce a count Nᵢ_{ⱼ}, as given in Equation 4:

Nᵢ_{ⱼ}=βτᵢ+Oⱼ+βdᵢ_{ⱼ}/c (4)

at receiver Rⱼ in an instance in which dᵢ_{ⱼ} is the distance between the object tag Tᵢ and the receiver 106 Rⱼ. Note that τᵢ is unknown, but has the same constant value for all receivers. Based on the equalities expressed above for receivers Rⱼ and Rₖ and given the reference tag 104 information, phase offsets expressed as differential count values are determined as given in Equations 5a-b:

$$\begin{matrix}{N}_{{R}_{j}} - {N}_{{R}_{k}} = ( {O}_{j} - {O}_{k} ) + β ( \frac{{d}_{{R}_{j}}}{c} - \frac{{d}_{{R}_{k}}}{c} ) \\ Or , & ( 5 a ) \\ ( {O}_{j} - {O}_{k} ) = ( {N}_{{R}_{j}} - {N}_{{R}_{k}} ) - β ( \frac{{d}_{{R}_{j}}}{c} - \frac{{d}_{{R}_{k}}}{c} ) = {Δ}_{{j}_{k}} & ( 5 b )\end{matrix}$$

In an instance in which Δⱼₖ is constant as long as d_{R}_{ⱼ}−d_{Rk} remains constant, (which means the receivers and reference tag are fixed and there is no multipath situation) and β is the same for each receiver. Note that Δⱼ_{ₖ} is a known quantity, since N_{R}_{ⱼ}, N_{R}_{ₖ}, β, d_{R}_{ⱼ}/c, and d_{R}_{ₖ}/c are known. That is, the phase offsets between receivers Rⱼ and Rₖ may be readily determined based on the reference tag 104 transmissions. Thus, again from the above equations, for a tag 102 (Tᵢ) transmission arriving at receivers Rⱼ and Rₖ, one may deduce the following Equations 6a-b:

$$\begin{matrix}{N}_{{i}_{j}} - {N}_{{i}_{k}} = ( {O}_{j} - {O}_{k} ) + β ( \frac{{d}_{{i}_{j}}}{c} - \frac{{d}_{{i}_{k}}}{c} ) = {Δ}_{{j}_{k}} + β ( \frac{{d}_{{i}_{j}}}{c} - \frac{{d}_{{i}_{k}}}{c} ) \\ Or , & ( 6 a ) \\ {d}_{{i}_{j}} - {d}_{{i}_{k}} = ( cI β ) [ {N}_{{i}_{j}} - {N}_{{i}_{k}} - {Δ}_{{j}_{k}} ] & ( 6 b )\end{matrix}$$

Each arrival time, tⱼ, can be referenced to a particular receiver (receiver “1”) as given in Equation 7:

$${t}_{j} = \frac{1}{β} ( {N}_{j} - {Δ}_{j 1} ) \qquad ( 7 )$$

The minimization, described in Equation 1, may then be performed over variables (x, y, z, t₀) to reach a solution (z′, y′, z′, t₀′).

In some embodiments, the receiver hub 108, may be configured to collect and average the tag locations for a predetermined period, for example, the last 100 tag locations, 1000 tag locations, one hour, 10 hours, or other period. The averaged tag location may minimize tag location variation, due to reflection, obfuscation, or movement of one or more receivers 106, or the like, and may result in a more accurate tag location.

In an example embodiment, the receiver hub 108 may additionally, an error associated with TOA for each receiver and the tag location. The receiver hub 108 may compare the receiver TOA errors to a predetermined TOA error threshold, and discard receiver TOA data which fails to satisfy the predetermined threshold. The receiver hub 108 may perform the tag location determination without the discarded receiver TOA data. The process may continue until all remaining receiver TOAs satisfy the TOA error threshold or a minimum number of receiver TOAs, e.g. 3, is reached.

In some example embodiments, a range detector 206 may deployed in and/or around a monitored area. A range detector 204 may be a laser range finder (LRF) or laser radar (LADAR), flash LiDAR, ultrasonic range finder, radar, such as operating between 22-24 or 60-90 GHz, or the like. In the depicted embodiment, the range detector is a laser range finder, such as a Fluke 414D, 419D, or 424D, or other range finder with at similar specifications, such as a measurement tolerance of +/−1-2 millimeters. Determination of a precision tag position with a LRF, such as the Fluke 414D may yield an accuracy of approximately ⅛ inch. Although a LRF is discussed throughout the application one of ordinary skill in the art would immediately appreciate that similar methods may be used with other range detectors. Although, a ⅛ to ¼ inch accuracy of precision tag positions is discussed throughout the application, one of ordinary skill in the art would understand that other subinch accuracies, such as 1/16, ½, or ¾ inch may also be yielded based on the specification of the range detector and or the number or range data received.

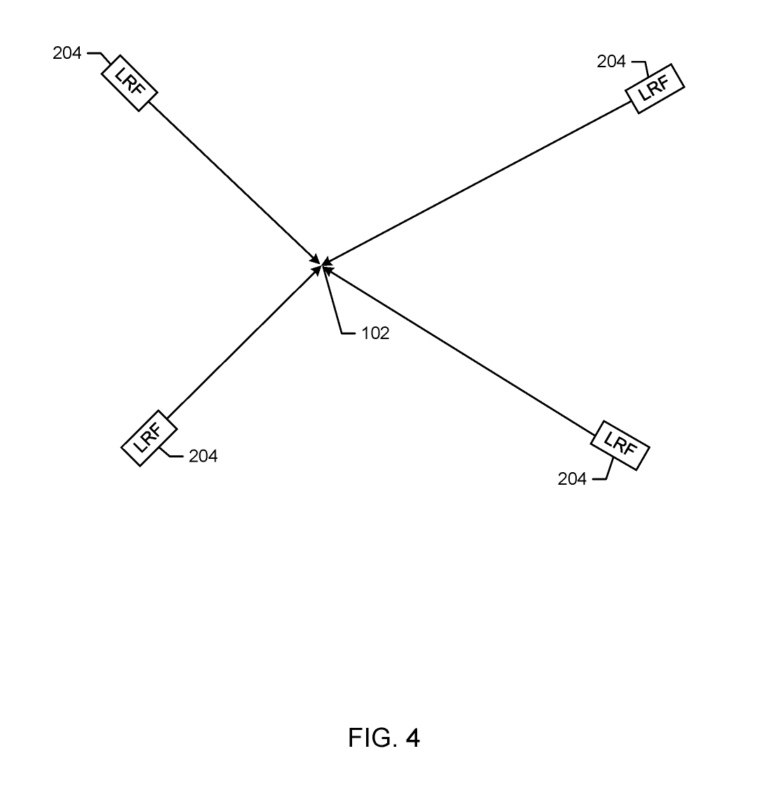

The receiver hub 108 may send control signals to servo actuators 202 associated with each LRF 204 to aim the LRF 204 at the location tag. The control signals may be based on the tag location determined, as discussed above. The LRF 204 may receive range data from the location tag 102. In an example embodiment, the LRF directs a laser beam at the tag location and receives a laser reflection from the location tag. The receiver hub 108 may receive the range data from the LRF 204 and determine a precision tag position, as discussed in FIG. 4.

As will be apparent to one of ordinary skill in the art, the inventive concepts herein described are not limited to use with the UWB based RF locating system shown in FIG. 1. Rather, in various embodiments, the inventive concepts herein described may be applied to various other locating systems especially those that are configured to provide robust location resolution (i.e., subfoot location resolution).

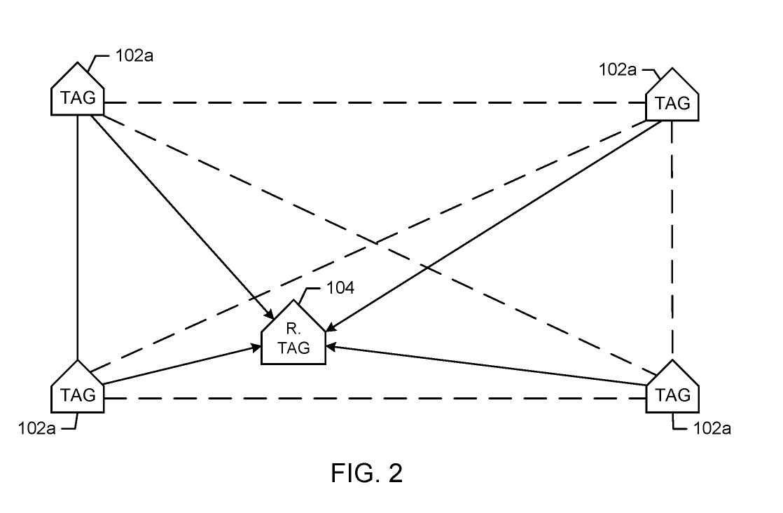

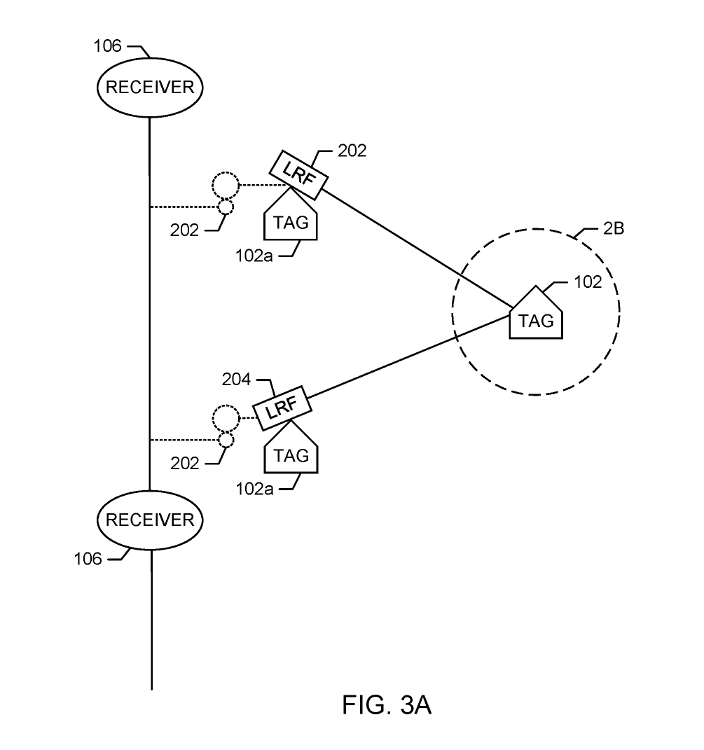

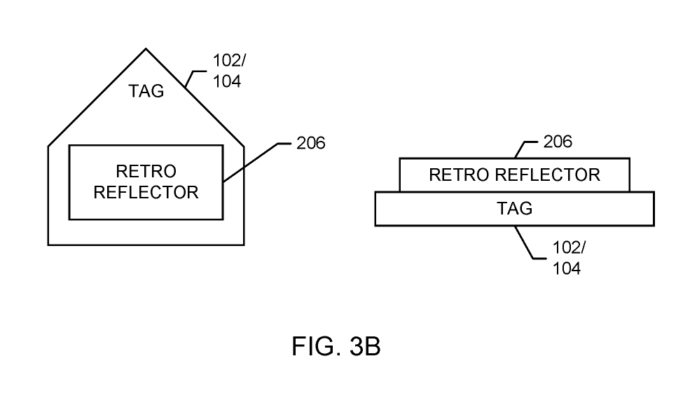

FIG. 2 illustrates an example monitoring grid and monitoring grid anchor determination in accordance with an example embodiment of the present invention. Location tags 102a may be positioned in association with receivers 106, LRFs 204 or receiver/LRF pairs. The receiver hub 108 may receive blink data from the respective receivers, which in turn receive the blink data from the location tags 102a and determine a tag location as discussed above in FIG. 1. The receiver hub 108 may transmit a control signal to the servo actuators 202, discussed in FIG. 3A. The servo actuators 202 may aim the LRFs 204 at the respective location tags 102a. The LRF 204 may receive range data, e.g. a laser reflection, from the location tags 102a, represented by the dashed lines. The receiver hub 108 may receive the range data from the LRFs 204 and triangulate a precision tag position for the location tags 102a. Since the location tags 102a are associated with the location of the receiver 106/LRF 204 pair the receive hub 108 may determine the respective positions of the receivers and LRFs relative to each other, e.g. a position monitoring grid.

The receiver hub 108 may also send a control signal to the servo actuators associated with the reference tag location of the reference tag 104. The servo actuators may aim the LRFs 204 at the reference tag 104 and receive range data associated with the reference tag, depicted by the solid lines. The receiver hub 108 may receive the range data associated with the reference tag 104 from the LRFs 204. The receiver hub 108 may determine, by triangulation, the position of the reference tag 104. Since the position of the respective LRFs 204 are known, the reference tag location anchors the position monitoring grid to the reference tag 104 position. In an example embodiment, the location tags 102a, associated with the receiver 106/LRF 204 pair may also be a reference tag mounted to a rigid support structure. The location tag 102a tag location and precision tag positions may also be used to anchor the monitoring grid.

The determination of the monitoring grid positions and anchor position allows the receiver hub 108 to determine the location of location tags 102, which may be mounted to various structure components or structural elements relative to the reference tag 104.

In an example embodiment, the locations of the receivers, e.g. monitoring grid, and location of the reference tag, monitoring grid anchor, may be determined by the receivers 106 and receiver hub 108 in a manner similar to the determination to the position monitoring grid and position monitoring anchor.

Additionally or alternatively, the locations and/or positions of the receivers 106, LRFs 204, and reference tag may be determined and entered or verified by a user via a user interface.

In some example embodiments, the receiver hub 108 may verify or recalibrate the monitoring grid and monitoring grid anchor at a predetermined interval to compensate for incidental receiver 106 movements or LRF 204 movements, such as an impact with the receiver or LRF, or the structure to which the receiver or LRF is mounted.

### Example Receiver and Range Detector Mount

FIG. 3A illustrates an example receiver 106 and LRF 204 mounting position in accordance with an example embodiment of the present invention. The receiver 108 and LRF 204 may be mounted to a mounting structure 208, such as a pole, scaffolding, building, or other rigid structure. Receivers 106 may be mounted in relatively close proximity to the LRF. 204. Several receiver 106/LRF 204 placement configuration may be used dependent on the monitored environment, number of available receivers/LRF pairs, monitored objects, or the like. In the depicted example, receiver 106/LRF 204 pairs are mounted at a high position and a low position. In an example embodiment, receiver 106/LRF 204 pairs may be mounted in a high or low position alternating between mounting positions. In an instance in which the receiver 106/LRF 204 pairs are mounted in high and low positions, the receiver hub may determine a three dimensional coordinate set of each tag location and/or precision tag position. In an alternative embodiment, the receiver 106/LRF 204 pairs may be mounted in a single height position, and the receiver hub may determine a two dimensional coordinate set of each tag location and/or precision tag position.

In some example embodiments, receiver 106/LRF 204 pairs may be mounted in intermediate positions, e.g. between the high position and low position. Intermediate positions may be useful in instances in which the location tag is occluded form one or more high or low positions. Such an occlusion may occur as a structure is constructed, such as floors added, blocking the line of sight of one or more location tags. Similarly, receiver 106/LRF pairs may be added at positions above the high position as construction of the structure progresses, e.g. becomes taller which additional floors or structure buildup, or lateral to a position as the structure expands.

A minimum of three receivers 106 may be used to determine a tag location and a minimum of three LRFs 204 may be used to determine a precision tag position. Preferably, the monitoring system may have four or more receiver 106/LRF 204 pairs mounted at a high position and four or more receiver 106/LRF 204 pairs mounted at a low position, allowing for determination of an over-determined tag location or precision tag position, as discussed in FIG. 1. Each set of four low and high mounted receiver 106/LRF 204 pairs, e.g. monitoring grid cube, may be a monitoring zone. Receiver 106/LRF 204 pairs may be used in multiple monitoring zones. In some example embodiments the monitoring zones may overlap.

In an example embodiment, the receiver hub 108 may be configured to determine tag locations for multiple location tags 102 in real time. In an instance in which the monitoring system is equipped with additional LRFs, such as six or more, the receiver hub may be configured to determine the precision tag position of multiple locations. For example, the receiver hub may be configured to determine a precision tag position for each set of three or more LRFs.

A servo actuator 202 may be mounted to the mounting structure 208, and the LRF may be mounted to the servo actuator. The servo actuator 202 may include two or more servo motors, aiming gears, and gyros configured to receive a control signal from the receiver hub 108, based on the tag location. The servo motors may be configured to aim the LRF in an x axis and a y axis, to be directed at a specified location tag 102 or reference tag 104. One such example of a servo actuator 202 may be a Jigabot AimE or similar device.

### Example Location Tag

FIG. 3B illustrates an example location tag in accordance with an example embodiment of the present invention. The location tag 102 or reference tag 104 may include a retro reflector 206 mounted to an exposed portion of the tag, such as the top of side of the location tag. A retro reflector may be a device or surface that reflects light back to its source, e.g. the LRF, with a minimum of scattering. One of ordinary skill in the art would immediately appreciate that other reflectors may be used in lieu of the retro reflector 206 in an instance in which the range detector is not light based, for example a radar reflector may be used in an instance in which the range detector is radar based.

The LRF 204, or other range detector, may be aimed using the servo actuators 202 at a tag location, associated with a specified tag UID. The LRF 204 may search a search area associated with the tag location for a maximum reflection, for example light backscatter, from the retro reflector 206.

In an instance in which a generic retro reflector, e.g. not unique to the location tag 102, is used, the location tags 102 may be placed at a distance of at least tag location accuracy, to prevent multiple location tags mounted in the same search area. For example, if the tag location accuracy is six inches, the location tags 102 may be placed at an interval of one foot or greater. In some instances, the retro reflector may be configured, such as during manufacturing, to return a specific range profile or frequency response, which may be associated to a specific location tag 102 and/or tag UID. In an instance in which a retro reflector 206 range profile or frequency response is associated with a specific location tag 102, the location tags may be placed within the accuracy of the tag location, since the LRF can differentiate between the retro reflectors and therefore differentiate the location tags.

### Example Precision Tag Position Determination

FIG. 4 illustrates an example precision tag position determination in accordance with an example embodiment of the present invention. The respective servo actuators LRFs 204 receive a control signal from the receiver hub 108, indicative of a tag location for a specified location tag 102, based on the location tag UID. The servo actuator 202 may aim the LRF at the specified location tag.

The LRF 204 may transmit a range laser beam, or other ranging medium, at the tag location. The LRF 204 may be configured to search an area around the tag location to find a maximum reflection, for example light backscatter, from a retro reflector 206. In an example embodiment, the LRF 204 search area may be twice the tag location accuracy, for example if the tag location accuracy is six inches, the search area may be one foot. The laser beam may be reflected by the retro reflector 206 and received by the LRF 204. Based on the time between the transmission of the laser beam and receipt of the laser reflection, the LRF 204 may determine range data, e.g. a distance measurement between the LRF and the location tag 102. For example, the LRF 204 may determine the range data using the equation d=t/c, where d is the distance for the LRF to the location tag 102, t is the time from transmission to receipt of the reflection of the laser, or other ranging medium, and c is the speed of light. The LRF 204 may transmit the range data to the receiver hub 108 for a position determination.

The receiver hub 108 may receive range data from each of the respective LRFs 204. The receiver hub 108 may be triangulate a precision tag position based on the positions of the LRFs 204 in the position monitoring grid, the position monitoring grid anchor, and three or more range data. The triangulation of the precision tag position may be substantially similar to the tag location determination and error minimization discussed in FIG. 1.

In some example embodiments, the receiver hub 108 may determine a precision tag position and shift to movement detection. Movement detection may include one or more LRFs determining range data and sending the range data to the receiver hub 108. The receiver hub may compare the range data to the range data received from the LRF providing the range data used for the precision tag position. In an instance in which the range data is satisfies a predetermined variation threshold, e.g. minimally changed from the previous range data, such as one unit of range accuracy, the receiver hub 108 may determine that the precision tag position has not changed. In an instance in which the range data fails to satisfy the predetermined variation threshold, e.g. significantly changed from the previous ranged data, the receiver hub 108 may determine that the precision tag position has changed. In an instance in which the receiver hub 108 determines that the precision tag position has changed, the receiver hub 108 may determine an updated precision tag position. In some example embodiments, the receiver hub 108 may designate different LRFs 204 for location tag 102 motion detection each iteration, which may allow for the receiver hub to determine a change in tag position in a single direction, which may not be a change in range relative to a single LRF.

### Example Tag Location and Precision Tag Position Radii

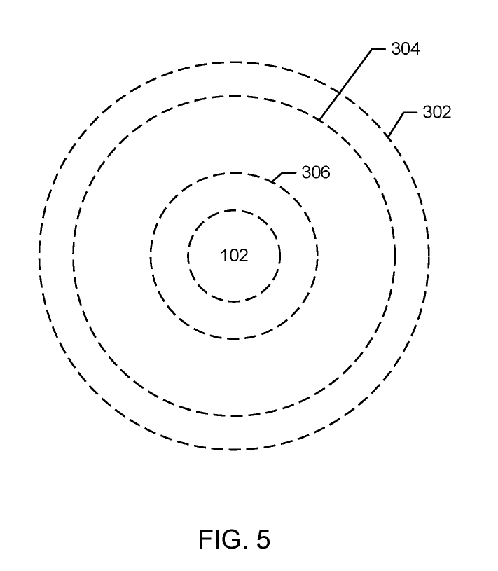

FIG. 5 illustrates and example tag location and precision tag position radii in accordance with an example embodiment of the present invention. The receiver hub 108 may determine a tag location of a location tag 102, as discussed in FIG. 1. The tag location may have a subfoot accuracy, such as a six inch radii, as depicted by the dashed circle 302 around the location tag 102. The LRF 204 may be aimed, as discussed in FIG. 3A, at the specified tag location based on the control signal received from the receiver hub 108. The LRF 204 may transmit a laser beam at the tag location. The laser beam may have a radius 304, which may be less than or equal to the tag location accuracy 302, such as a six inch beam. The LRF 204 may receive the range data, e.g. the laser reflection from the location tag 102. The LRF 204 may transmit the range data to the receiver hub 108 for determination of the precision tag position. The receiver hub 108 may determine a high accuracy precision tag position. For example, the precision tag position accuracy radii 306 may be ¼ or ⅛ inch.

### Example Structure Component or Structural Element Position Determination

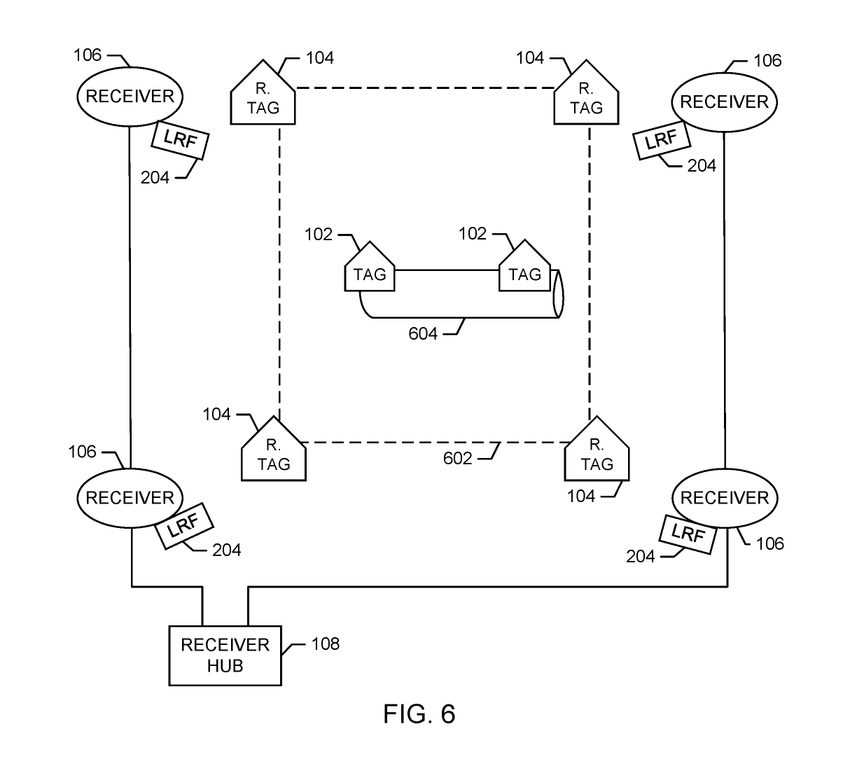

FIG. 6 illustrates an example structure component or structural element position determination in accordance with an example embodiment of the present invention. Reference tag 104 and location tags 102 may be correlated with specified locations in a three dimensional model, such as a CAD model. In an example embodiment, tag UIDs of reference tags 104, and location tags 102, may be assigned to each location of interest in the three dimensional model. In an example embodiment, reference tags 104 may be correlated with fixed positions of the structure such as foundation corners. Location tags 102 may be correlated to one or more points, e.g. target positions, of a structure component or structural element 604. In some embodiments a target position threshold may also be designated for each location tag 102 tag location. Location tags 102 may be assigned to any location of interest in the three dimensional model, but are preferably spaced at a distance so that location tags are further apart than the tag location accuracy, for example if the tag location accuracy is six inches, location tags 102 may be placed one foot or more apart. Spacing the location tags greater than the tag location accuracy, allows the use of a generic retro reflector to be utilized, since only one location tag 102 will be present in the LRF 204 search area. In an instance in which the retro reflector has a unique reflection pattern, location tags 102 may be placed closer than the tag location accuracy, since the LRF may be configured to differentiate between retro reflector reflection patterns associated with each location tag.

In an example embodiment, a designated structure associated with a fixed point 602 may be constructed in the structure construction site, for example the foundation of a building may be poured. Reference tags 104 may be mounted in designated locations to one or more fixed points 602, e.g. reference points, of the structure. The reference tags 104 may anchor the monitoring grid as discussed in FIG. 2. Additionally, the reference tags 104 may provide a reference point for location tag 102 locations and positions as discussed above.

Location tags 102 may be mounted to one or more predetermined positions on a structure component or structural element 604. The structure component or structural element 604 may be placed in the structure. The receiver hub 108 may determine the tag location for the respective location tags 102 associated with the structure component or structural element 604, as discussed above in FIG. 1. The receiver hub 108 may send a control signal to the servo actuators 202 associated with the LRFs based on the tag location. The servo actuators 202 may aim the LRFs 204 toward the location tags 102 based on the control signal. The LRFs may receive range data from the location tags 102, e.g. laser reflections. The LRFs 204 may send the range data to the receiver hub to determine a precision tag position as discussed above in FIG. 4.

In some example embodiments, the magnetic control transmitter may be used to cause the location tag to commence blinking when the location tag is relatively near the target location. Since the location tag 102 transmits blink data after it is activated near the target location, the receiver hub 108 is not processing the tag location until the tag location and precision tag position becomes relevant to the construction operation.

The receiver hub 108 may compare the tag location and/or the precision tag position to the target position of a three dimensional model, e.g. CAD model. In an example embodiment, the tag location and/or precision tag position may be compared to a predetermined target position threshold, for example ¼ or ½ inch. The receiver hub 108 may transmit an indication of the tag location and/or precision tag position to a user interface, indicating the tag location and/or precision tag position compared to the target position. In an example embodiment, the receiver hub 108 may transmit an alert in an instance in which the tag location and/or precision tag position does not satisfy the target position threshold.

In some example, embodiments, the receiver hub 108 may transmit an alert based on an absolute change in the tag location or precision tag position, such as a change between a current and previous tag location or precision tag position. In an example embodiment, the receiver hub 108 may transmit an alert, based on an absolute change in tag location or precision tag position in an instance in which the tag location or precision tag position has changed from a previous tag location or precision tag position for a predetermined number of tag location or precision tag position determinations, to prevent alert transmissions based on an erroneous tag location or precision tag position.

In an example embodiment, the receiver hub 108 may transmit alerts based on additional or alternative criteria. For example, the receiver hub 108 may transmit alerts based on tag location changes, such as materials having a location tag 102 mounted thereto for loss prevention of the materials. In another example, the location tags 102 may be worn by some or all of the constructions crew. The receiver hub 108 may be configured to transmit an alert in an instance in which the tag location associated with a construction crew member is indicative of a rapid vertical movement and/or a cessation of movement, indicative of a fall or injury.

In an example embodiment, tag location data associated with the construction crew members may be collected for analysis of the construction crew and/or construction site. For example, the receiver hub 108 may output the total movement of the construction crew members which may be used as an indicator of effort. In another example, the receive hub 108 may output the tag location patterns of the construction crew, which may be used to improve efficiency, such as moving materials to shorten routes, or reduce chokepoints.

Returning to structure component and structural element position and location determinations, in some example embodiments, the receiver hub 108 may iteratively determine tag locations and precision tag positions at a predetermined interval, such as once every 15 minutes, 30 minutes, hour, day, or the like. A change in position of a location tag 102, e.g. failing to satisfy the target position threshold, after previously satisfying the target position threshold, may be indicative of a shift in the structure component or structural element during constructions. The alert may be useful to construction crews to determine and correct variations or shifts in structure components or structural elements in real time or near real time.

In an example embodiment, the receiver hub 108 may be configured to determine if location tags 102 are in a transitory or non-transitory state. The receiver hub 108 may compare the current tag location to one or more previously determined tag locations. In an example embodiment, the receiver hub 108 may compare changes in the tag location to a predetermined transitory threshold. In an instance in which the change in tag location satisfies the transitory threshold, e.g. the tag has not changed greater than a predetermined amount over a predetermined number of tag location determinations; the receiver may classify the location tag in a non-transitory state. In an instance in which the change in tag location fails to satisfy the transitory threshold, e.g. the tag location has changed greater than the predetermined amount over a predetermined number of tag location determinations; the receiver hub 108 may classify the tag in a transitory state.

In some example, embodiments the receiver hub 108 may suspend precision tag position determinations of the location tags 102 which are classified as transitory to prevent hunting of the servo actuators 202, which may result in unnecessary wear and/or irrelevant precision tag position determinations.

Additionally or alternatively, location tags 102 may also include sensors, such as accelerometers to determine if the tag is in motion. The location tag 102 may transmit motion sensor data to the receiver hub 108, for example, as a portion of the tag blink data. In an instance in which the receiver hub 108 receives sensor data indicative of the location tag 102 in motion, the receiver hub may classify the location tag in a transitory state. In an instance in which the receiver hub 108 receives sensor data indicative of the location tag 102 not in motion, the receiver hub may classify the location tag in a non-transitory state.

Additionally or alternatively, location tags 102 including an accelerometer, or other motion sensor, may be configured to transmit blink data based on the sensor data. In an instance in which the sensor data indicates that the location tag 102 is not in motion, the location tag may transmit blink data or transit blink data at a first blink rate, e.g. a high rate, such as 8, 16, 32, or 187 blinks per msec. In an instance in which the sensor data indicates that the location tag 102 in in motion, the location tag may transmit blink data at a second blink rate, e.g. a low rate, such as 1 blink per minute. In an example embodiment, the receiver hub 108 may determine the location tag 102 to be in a transitory or non-transitory state based on the blink rate of the location tag.

In an example embodiment, the receiver hub 108 may iteratively determine tag locations and precision tag positions based on a priority hierarchy, in which specified tags are monitored more often than other location tags. The monitoring priority of a location tag 102 may be based on a level of interest designated for a target location associated with the three dimensional model, the transitory state of the location tag, location tag occlusion or the like.

In an example embodiment, sensors, such as GPS sensor, may be placed in specified locations. The receiver hub 108 may determine a sensor position, or tag position in an instance in which the sensor is associated with a location tag 102. A sensor position, such as GPS survey, may have a short term accuracy of 10 feet, which may increase to an accuracy of ¼-½ inch over a longer period such as twenty four hours. In an example embodiment, the sensor position may be used in addition or as an alternative to the tag location for aiming the LRF 204.

### Example Precision Tag Position Determinations Based on Other Precision Tag Positions

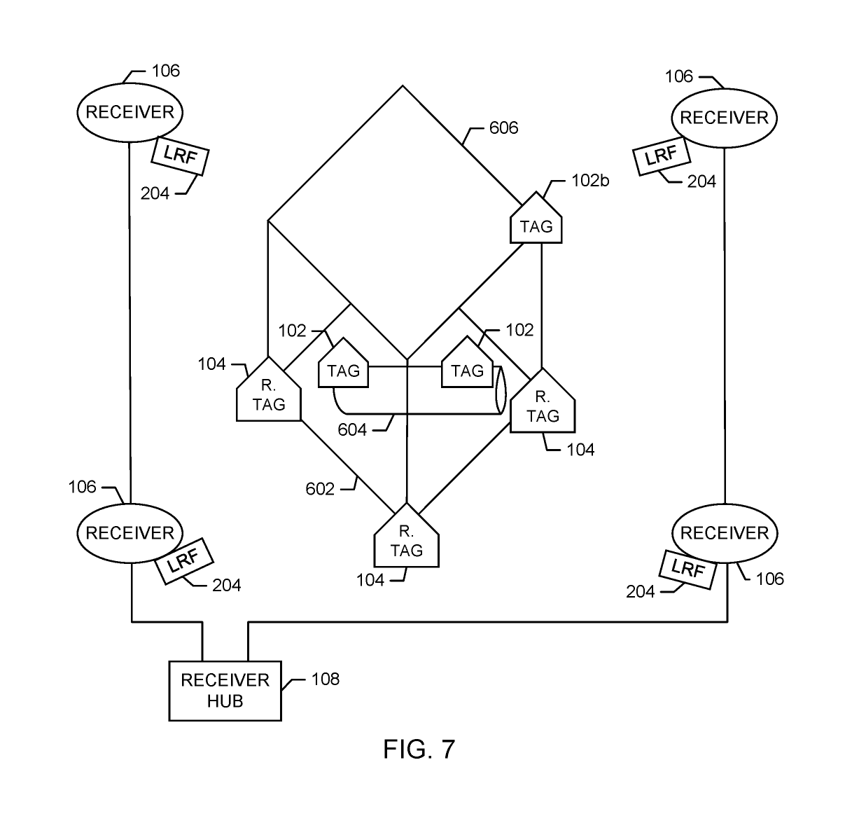

FIG. 7 illustrates an example precision tag position determination based on other precision tag positions in accordance with an example embodiment of the present invention. In an example embodiment, additional location tags 102b may be mounted to additional structure components or structural elements 606, for example, a second floor may be constructed in a structure. The receiver hub 108 may determine the tag location and/or precision tag position of the additional location tag 102b, as discussed above in FIGS. 1 and 4. The receiver hub 108 may compare the tag location and/or precision tag position to the target position based on the reference tag location 104 and additionally the location tags 102. As such, the receiver hub 108 may determine if the tag location for the location tags 102 and the additional location tags 102 satisfy the target position threshold based on their respective location in relation to the reference tags 104 and the location tags 102/102b. The cross comparison of location tags 102/102b, as a structure is constructed allows for the structure components and structural element 604/606 positions to be determined and monitored in reference to the fixed reference points 602, and the specified structure components and structural elements. The cross comparison of location tag 102/102b tag locations and tags positions may allow for robust monitoring of a structure construction, not previously possible.

In an example embodiment, the target location threshold may include additional relative determinations based on the additional location tags, e.g. does the tag location or precision tag position satisfy a predetermined threshold target location based on, e.g. relative to, the tag location or precision tag position of the other location tags 102/102b, such as a relative target location threshold.

The receiver hub 108 may determine if the tag location or precision tag position satisfies a relative target position threshold. In an instance in which, the tag location satisfies the relative target position threshold, the receiver hub may transmit an indication to the user interface indicative of the tag location or precision tag position satisfying the target location threshold and the relative target location threshold. In an instance in which the tag location or precision tag positions fails to satisfy the relative target location threshold, the receiver hub 108 may transmit an indication to the user interface indicative of the tag location and/or precision tag position failing to satisfy the target location and/or relative target location threshold. Additionally, the receiver hub may transmit and alert in an instance in which the tag location and/or precision tag position fail to satisfy the relative target location threshold.

The cross comparison of location tags 102/102b, may be of particular use in an instance in which location tags 102/102b or reference tags are obfuscated, or if the structure is large causing some location tags to be relatively distant from reference tag locations.

In some example embodiments, additional receivers 106 and/or LRFs 204 may be added during the construction process. For example, the mounting structure may be extended and additional receiver 106 and/or LRFs 204 may be added as the structure is constructed horizontally, vertically, or both.

In some embodiments, receivers 108/and or LRFs 204 may be mounted within or attached to the structures, such as on arms connected to each floor. The receivers 106 and LRFs on the mounted to or within the structure may allow for tag location and precision tag positions to be determined when one or more receiver or LRFs outside of the structure have been occluded by the construction of the structure.

### Example Apparatus

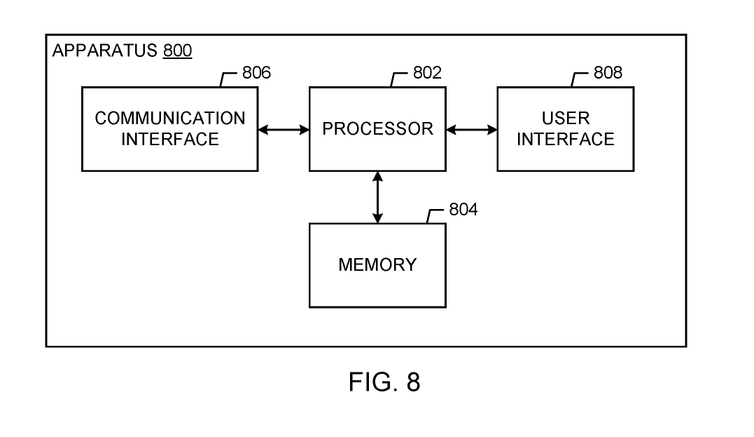

FIG. 8 shows a block diagram of components that may be included in an apparatus 800 is configured for determining an object position based on range data and determined location data in accordance with embodiments discussed herein. The apparatus 800, may be embodied in or otherwise associated with the receiver hub 108. In some examples, apparatus 800 may be embodied by or enable operation of one or more blocks as described herein. Apparatus 800 may comprise one or more processors, such as processor 802, one or more memories, such as memory 804, communication circuitry 806, and user interface 808. Processor 802 can be, for example, a microprocessor that is configured to execute software instructions and/or other types of code portions for carrying out defined steps, some of which are discussed herein. Processor 802 may communicate internally using data bus, for example, which may be used to convey data, including program instructions, between processor 802 and memory 804.

Memory 804 may include one or more non-transitory storage media such as, for example, volatile and/or non-volatile memory that may be either fixed or removable. Memory 804 may be configured to store information, data, applications, instructions or the like for enabling apparatus 800 to carry out various functions in accordance with example embodiments of the present invention. For example, the memory could be configured to buffer input data for processing by processor 802. Additionally or alternatively, the memory could be configured to store instructions for execution by processor 802. Memory 804 can be considered primary memory and be included in, for example, RAM or other forms of volatile storage which retain its contents only during operation, and/or memory 804 may be included in non-volatile storage, such as ROM, EPROM, EEPROM, FLASH, or other types of storage that retain the memory contents independent of the power state of the apparatus 800. Memory 804 could also be included in a secondary storage device, such as external disk storage, that stores large amounts of data. In some embodiments, the disk storage may communicate with processor 802 using an input/output component via a data bus or other routing component. The secondary memory may include a hard disk, compact disk, DVD, memory card, or any other type of mass storage type known to those skilled in the art.

In some embodiments, processor 802 may be configured to communicate with external communication networks and devices using communications circuitry 806, and may use a variety of interfaces such as data communication oriented protocols, including X.25, ISDN, DSL, among others. Communications circuitry 806 may also incorporate a modem for interfacing and communicating with a standard telephone line, an Ethernet interface, cable system, and/or any other type of communications system. Additionally, processor 1202 may communicate via a wireless interface that is operatively connected to communications circuitry 806 for communicating wirelessly with other devices, using for example, one of the IEEE 802.11 protocols, 802.15 protocol (including Bluetooth, Zigbee, and others), a cellular protocol (Advanced Mobile Phone Service or “AMPS”), Personal Communication Services (PCS), or a standard 3G wireless telecommunications protocol, such as CDMA2000 1×EV-DO, GPRS, W-CDMA, LTE, and/or any other protocol.

The apparatus 800 may include a user interface 808 that may, in turn, be in communication with the processor 802 to provide output to the user and to receive input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g. software and/or firmware) stored on a memory accessible to the processor (e.g. memory 804, and/or the like).

Any such computer program instructions and/or other type of code may be loaded onto a computer, processor or other programmable apparatuses circuitry to produce a machine, such that the computer, processor or other programmable circuitry that executes the code may be the means for implementing various functions, including those described herein.

### Example Process for Determining an Object Position Based on Range Data and Determined Location Data

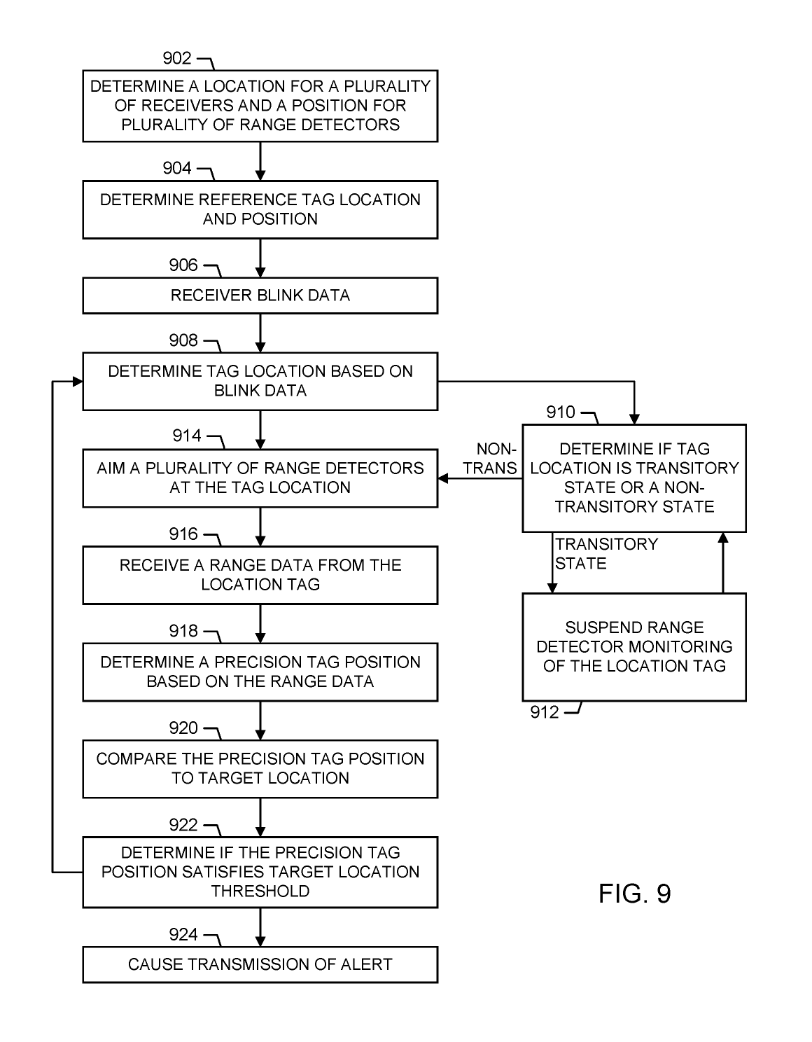

Referring now to FIG. 9, the operations performed, such as by the apparatus 200 of FIG. 2, for determining an object position based on range data and determined location data are illustrated. As shown in block 902 of FIG. 9, the apparatus 200 may include means, such as a processor 802, memory 804, a communications interface 806, user interface 808, or the like, configured to determine a location for a plurality of receivers 106 and a position for a plurality of range detectors 204. The processor 802 may receive blink data, from the communications interface 806, which in turn receives the blink data from one or more location tags 102 associated with the receivers 106 and/or the range detectors 204. The processor 802 may determine the location of the location tags 102a as described in FIG. 1. The processor 802 may transmit a control signal to a servo actuator 202 associated with the respective range detector 204, based on the tag location. The servo actuator 202 may aim the range detector toward the location tag 102a, and receive range data form the location tag. For example, in an instance in which the range detector is a laser range finder (LRF) the range data may be a laser reflection. The receiver hub 108 may receive the range data from, the communications interface 806, which in turn receives the range data form the range detector 204 and determine a precision tag position for the location tag 102a, as discussed above in FIG. 4. The tag locations and precision tag positions of the location tags 102a associated with the plurality of receivers 106 and/or plurality of range detectors 204, may be constitute a monitoring grid.

In an example embodiment, receiver locations and/or range detector positions may be entered or verified by a user via a user interface 808. The receiver locations and range detector locations may be stored in a memory 804 for further location determinations.

As shown in block 904 of FIG. 9, the apparatus 200, may include means, such as a processor 802, memory 804, communications interface 806, user interface 808, or the like, configured to determine a reference tag location. The processor 802 may receive blink data from the communications interface 806, which in turns receives the blink data from a reference tag 104. The processor 802 may determine the reference tag location as described above in FIG. 1. The processor 802 may transmit a control signal to the servo actuators 202 associated with the range detectors 204, based on the reference tag location. The servo actuators 202 may aim the range detectors 204 toward the reference tag 104 and receive range data form the reference tag. The processor 802 may receive the range data from the communication interface 206, which in turn receives the range data from the range detectors 204. The processor 802 may determine a reference precision tag position as described in FIG. 4. The reference tag location may anchor the monitoring grid to the reference location, e.g. reference point.

In an example embodiment, the location tags 102a may also serve as reference tags and may additionally anchor the monitoring grid to one or more reference points.

In some example embodiments, the processor may verify or recalibrate the monitoring grid and monitoring grid anchor at a predetermined interval, such as one minute ten minutes, 1 hour, or other interval, to compensate for incidental changes in receiver 106 or LRF 204 position.

In an example embodiment, one or more reference tags may be mounted to one or more fixed position of a structure. The reference tags 104 and associated mounting positions may be correlated specified locations in a three dimensional model, such as a CAD model, of a structure.

Additionally or alternatively, the reference tag location may be entered or verified by a user via a user interface 808. The reference tag location and reference precision tag position may be stored in a memory 804 for further tag location and precision tag position determinations.

As shown in block 906 of FIG. 9, the apparatus may include means, such as a processor 802, communications interface 806, or the like, configured to receive blink data. The processor 802 may receive blink data from the communications interface 806, which in turn receives the blink data form a location tag 102.

In an example embodiment the location tag 102 may be mounted to a predetermined position on a structure component or structure element. The location tags 102 and respective mounting positions may be correlated to a specified location in the three dimensional model of the structure. The location tags 102 may be correlated based on the respective location tag UIDs.

In some example embodiments, the blink data may also include sensor data, such as temperature data, motion data, strain data, or the like. The sensor data may be used by the processor 802 for various analytic determinations.

As shown in block 908 the apparatus 200 may include means, such as a processor 802, or the like, configured to determine a tag location based on the blink data. The processor 802 may determine the tag location based on the blink data received form the location tag 102, as discussed in FIG. 1.

In an example embodiment in which the processor 802 is configured to determine if the location tag is in a transitory or non-transitory state, the process may continue at block 910. In an instance in which the processor is not configured to determine if the location tag 102 is in a transitory or non-transitory state, the process may continue at block 914.

As shown in block 910, the apparatus 200 may include means, such as a processor 802, or the like configured to determine if a location tag is in a transitory state or a non-transitory state. The processor 802 may determine the location tag to be in a transitory or non-transitory state by comparing the current tag location to one or more previously determined tag locations. The processor 802 may also compare the change in tag location between the current and previous tag locations to a predetermined transitory threshold. In an instance in which the processor 802 determines that the change in tag location satisfies the transitory threshold, e.g. the tag has not changed greater than a predetermined amount over a predetermined number of tag location determinations; the receiver may classify the location tag in a non-transitory state. In an instance in which the change in tag location fails to satisfy the transitory threshold, e.g. the tag location has changed greater than the predetermined amount over a predetermined number of tag location determinations; the processor 802 may classify the tag in a transitory state.

Additionally or alternatively, location tags 102 may also include sensors, such as accelerometers to determine if the tag is in motion. The location tag 102 may transmit motion sensor data to the processor 802, for example, as a portion of the blink data. In an instance in which the processor 802 receives sensor data indicative of the location tag 102 in motion, the processor may classify the location tag in a transitory state. In an instance in which the processor 202 receives sensor data indicative of the location tag 102 not in motion, the processor may classify the location tag in a non-transitory state.

Additionally or alternatively, location tags 102 including an accelerometer, or other motion sensor, may be configured to transmit blink data based on the sensor data. In an instance in which the sensor data indicates that the location tag 102 is not in motion, the location tag may transmit blink data or transit blink data at a first blink rate, e.g. a high rate, such as 8, 16, 32, or 187 blinks per msec. In an instance in which the sensor data indicates that the location tag 102 in in motion, the location tag may transmit blink data at a second blink rate, e.g. a low rate, such as 1 blink per minute. In an example embodiment, the processor 802 may determine the location tag 102 to be in a transitory or non-transitory state based on the blink rate of the location tag.

In an instance in which the processor 802 determines that the location tag 102 is in a non-transitory state the process may continue at block 914. In an instance in which the processor 802 determines that the location tag 102 is in a transitory state, the process may continue at block 912.

As shown in block 912 of FIG. 9, the apparatus may include means, such as a processor 802, or the like, configured to suspend range detector monitoring of the location tag. In an instance in which the processor 802 has determined that the location tag 102 is in a transitory state in block 910, the processor may suspend the range detector monitoring of the location tag, to prevent excess wear on the servo actuators 202 and unnecessary precision tag position determinations. Suspension of the range detector monitoring may include suspending the performance of blocks 914-922 of the specified location tag 102. The process may continue at block 910.

As shown in block 914 of FIG. 9, the apparatus 200 may include means such as a processor 802, a communications interface 806, or the like, configured to aim a plurality of range detectors toward the location tag. The processor 802 may cause the communications interface 806 to transmit a control signal to the servo actuators 202, based on the tag location. The servo actuators 202 may aim the range detectors, e.g. LRFs, at the tag location.

As shown in block 916 of FIG. 9, the apparatus 200 may include means, such as a processor 802, a communications interface 806, or the like, configured to receive range data from the location tag. The processor 802 may receive range data from the communications interface 806, which in turn receives the range data from the range detectors 204. The range detectors 204 may receive the range data from the location tags 102. In an example embodiment in which the range detectors 204 are LRFs, the range data may be laser reflections reflected from retro reflectors 206 mounted to the location tags 102.

As shown in block 918 of FIG. 9, the apparatus may include means, such as a processor 802, or the like configured to determine a precision tag position based on the range data. The processor 802 may determine the precision tag position by triangulation of the range data, as discussed in FIG. 4.

As shown in block 920 of FIG. 9, the apparatus may include means, such as a processor 802 configured to compare the precision tag position to a target location for a respective location tag 102. The processor 802 may compare the determined precision tag position and/or tag location to a target location of the three dimensional model. The processor 802 may determine a distance between the determined precision tag position or tag location and the target location.

In some example embodiments, the processor 802 may also compare the precision tag positions other, e.g. a second, location tag 102b tag location. The processor 802 may determine the relative distance between precision tag positions or tag locations and the respective target locations.

A shown in block 922, the apparatus 200 may include means, such as a processor 802, or the like, configured to determine if the precision tag position satisfies a target location threshold. The processor 802 may compare the distance of the precision tag position from the target position to a predetermined target location threshold, such as ¼ or ½ inch. In an example embodiment, the processor may determine that the target location threshold is satisfies, in an instance in which the distance between the target location and the precision tag position of tag location is less than the target location threshold. The processor 802 may determine that the target location threshold is not satisfied, in an instance in which the distance between the target location and the tag location or precision tag position is greater that the target location threshold.

In an example embodiment, the processor 802 may, additionally or alternatively, determine if the precision tag position satisfies a relative target location threshold. The processor 802 may compare the distance between the target locations and tag locations and or precision tag positions to a relative target location threshold. The processor 802 may determine that the distance between target locations of a first and second tag location and the tag locations/and or precision tag positions of the first and second location tag satisfies the relative target location threshold, in an instance in which the distance is less than the relative target location threshold. The processor 802 may determine that the distance between target locations of a first and second tag location and the tag locations/and or precision tag positions of the first and second location tag fails to satisfy the relative target location threshold, in an instance in which the distance is greater than the relative target location threshold.

The processor 802 may cause the tag locations, precision tag positions, target location threshold, and/or relative target location threshold terminations to be displayed on a user interface 808.

The process may continue at block 906, in an instance in which the location tag locations and precision tag positions are determined iteratively at a predetermined interval, such as every 15 minutes, 30 minutes, 1 hour, day or the like.

As shown in block 924 of FIG. 9, the apparatus 200 may include means such as a processor 802, communications interface 806, user interface 808, or the like to cause the transmission of an alert. The processor 802 may cause the user interface 206 to cause the transmission of an alert in an instance in which the tag location or precision tag position fails to satisfy a target location threshold or a relative target location threshold. The processor 802 may cause the transmission of the alert in real time or near real time, as each tag location and precision tag position is determined.

In an example embodiment, the processor may 802 cause the transmission of an alert in an instance in which a change in the absolute tag location or precision tag position is determined, e.g. the tag location or precision tag position has change relative to a previous tag location or precision tag position determination. The change in absolute tag location or precision tag position alert may be useful for identifying a location tag variation or to prevent loss of materials at a construction site by mounting a tag to the materials.

In some example embodiments, processor 802 may cause the transmission of an alert based on construction crew member locations. In an instance in which one or more construction crew members is associated with a location tag 102, the processor may cause and alert in an instance in which tag location associated with a construction crew member indicates a rapid change in vertical location and/or a cessation of motion indicating a fall or injury.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

1. A system for monitoring target locations of components in construction of a structure comprising:
a location tag configured to transmit blink data;
a plurality of receivers configured to receive the blink data;
a plurality of range detectors configured to receive range data from the location tag; and
a receiver hub in data communication with the plurality of receivers and the plurality of range detectors, configured to
receive blink data from the plurality of receivers;
determine a tag location based on the blink data;
receive range data from the plurality of range detectors based on the tag location; and
determine a precision tag position based on the range data.

2. The system for monitoring target locations of components in construction of a structure of claim 1, wherein the receiver hub is further configured to:
aim the plurality of range detectors based on the tag location; and
wherein the receiving range data comprises receiving a plurality of reflections from the location tag.

3. The system for monitoring target locations of components in construction of a structure of claim 1, wherein the receiver hub is further configured to:
compare the precision tag position to a target location; and
determine if the precision tag position satisfies a target location threshold.

4. The system for monitoring target locations of components in construction of a structure of claim 1, wherein the receiver hub is further configured to:
cause the transmission of an alert in an instance in which the precision tag position fails to satisfy the target location threshold.

5. The system for monitoring target locations of components in construction of a structure of claim 1 further comprising:
a plurality of reference tags associated with the plurality of receivers and the plurality of range detectors, configured to transmit reference blink data,
wherein the plurality of receivers are further configured to receive reference blink data from the plurality of reference tags associated with the plurality of receivers
wherein the plurality of range detectors are further configured to receive reference range data from the plurality of reference tags associated with the plurality of range detectors,
wherein the receiver hub is further configured to:
receive reference blink data from the plurality of receivers;
determine reference tag locations associated with locations of the respective receivers of the plurality of receivers based on the reference blink data;
receive reference range data from the plurality of range detectors based on the reference tag locations; and
determine a reference precision tag position associated with positions of the respective range detectors of the plurality of range detectors based on the reference range data;
wherein the determining the tag location is further based on a reference tag locations of the respective receivers, and
wherein the determining the precision tag position is further based on the reference precision tag positions of the respective range detectors.

6. The system for monitoring target locations of components in construction of a structure of claim 1 further comprising:
a reference tag associated with a reference point configured to transmit reference blink data;
wherein the plurality of receivers are further configured to receive reference blink data from reference tags,
wherein the plurality of range detectors are further configured to receive reference range data from the reference,
wherein the receiver hub is further configured to:
receive reference blink data from the plurality of receivers;
determine a reference tag location;
receive reference range data from the plurality of range detectors based on the reference tag location; and
determine a reference precision tag position;
wherein the determining the tag location is further based on a reference tag location, and
wherein the determining the precision tag position is further based on the reference precision tag position.

7. The system for monitoring target locations of components in construction of a structure of claim 2, wherein the receiver hub is further configured to:
determine if the tag location is in a transitory state or a non-transitory state; and
suspend the aiming the range detectors, the receiving a plurality of laser reflections, and determining the precision tag position, in an instance in which the tag location is determined to be in a transitory state.

8. The system for monitoring target locations of components in construction of a structure of claim 1, wherein the plurality of range detectors comprise a plurality of laser range finders and the range data comprises a laser reflection.

9. The system for monitoring target locations of components in construction of a structure of claim 1, wherein the tag location and precision tag position comprise a three dimensional coordinate set.

10. The system for monitoring target locations of components in construction of a structure of claim 1, wherein the tag location and precision tag position comprise a two dimensional coordinate set.

11. A method comprising:
receiving blink data from location tag at a plurality of receivers;
determining a tag location based on the blink data;
receiving range data from the location tag at a plurality of range detectors based on the tag location; and
determining a precision tag position based on the range data.

12. The method of claim 11 further comprising:
aiming the plurality of range detectors based on the tag location; and
wherein the receiving range data comprises receiving a plurality reflections from the location tag.

13. The method of claim 11 further comprising:
comparing the precision tag position to a target location; and
determining if the precision tag position satisfies a target location threshold.

14. The method of claim 13 further comprising:
causing the transmission of an alert in an instance in which the precision tag position fails to satisfy the target location threshold.

15. The method of claim 11 further comprising:
determining locations of the respective receivers of the plurality of receivers and a positions of respective range detectors of the plurality of range detectors, and
wherein determining the tag location is further based on the locations of the respective receivers and determining the precision tag position is further based on the positions of the respective range detectors.

16. The method of claim 11 further comprising:
determining a reference location, and
wherein the determining the tag location and determining the precision tag position is further based on the reference location.

17. The method of claim 12 further comprising:
determining if the tag location is in a transitory state or a non-transitory state; and
suspending the aiming the laser range finder, the receiving a plurality of laser reflections, and determining the precision tag position, in an instance in which the tag location is determined to be in a transitory state.

18. (canceled)

19. (canceled)

20. (canceled)

21. A method for monitoring target locations of components in construction of a structure comprising:
receiving blink data from location tag mounted on a structure component at a plurality of receivers;
determining a tag location based on the blink data;
receiving range data from the location tag at a plurality of range detectors based on the tag location; and
determining a precision tag position based on the range data.

22. The method for monitoring target locations of components in construction of a structure of claim 21 further comprising:
aiming the plurality of range detectors based on the tag location; and
wherein the receiving range data comprises receiving a plurality of reflections from the location tag.

23. The method for monitoring target locations of components in construction of a structure of claim 21 further comprising:
comparing the precision tag position to a target location, wherein the target location is defined by a three dimensional model of the structure; and
determining if the precision tag position satisfies a target location threshold.

24. The method for monitoring target locations of components in construction of a structure of claim 23 further comprising:
causing the transmission of an alert in an instance in which the precision tag position fails to satisfy the target location threshold.

25. The method for monitoring target locations of components in construction of a structure of claim 21 further comprising:
determining locations of the respective receivers of the plurality of receivers and a positions of respective range detectors of the plurality of range detectors, and
wherein determining the tag location is further based on the locations of the respective receivers and determining the precision tag position is further based on the positions of the respective range detectors.

26. The method for monitoring target locations of components in construction of a structure of claim 21 further comprising:
receiving reference blink data from a reference tag mounted at a fixed position on the structure;
determining a reference location based on the reference blink data, and
wherein the determining the tag location and determining the precision tag position is further based on the reference location.

27. The method for monitoring target locations of components in construction of a structure of claim 22 further comprising:
determining if the tag location is in a transitory state or a non-transitory state; and
suspending the aiming the laser range finder, the receiving a plurality of laser reflections, and determining the precision tag position, in an instance in which the tag location is determined to be in a transitory state.

28. (canceled)

29. (canceled)

30. (canceled)

31. The method for monitoring target locations of components in construction of a structure of claim 21 further comprising:
receiving blink data from a second location tag mounted to the structure or structural component;
determining a second tag location based on the blink data from the second location tag;
receiving range data form the second location tag based on the second tag location;
determining a second precision tag position based on the range data; and
wherein the comparing the precision tag position to the target location is further based on the second precision tag position.
